(19) United States
(12) Patent Application Publication
(10) Pub. No.: US 2025/0289719 A1
(43) Pub. Date: Sep. 18, 2025

(54) METHODS OF PREPARING DENSIFIED CARBON NANOTUBE (DCN) STRUCTURES AND THE USES THEREOF

(71) Applicant: 4th Phase Technologies, Inc., Wilmington, DE (US)

(72) Inventor: Chunhong Li, West Chester, PA (US)

(21) Appl. No.: 18/605,458

(22) Filed: Mar. 14, 2024

(51) Int. Cl. C01B 32/174

(52) U.S. Cl. CPC C01B 32/174; C01B 2202/22; C01P 2004/03; C01P 2004/13; C01P 2006/40

(57) ABSTRACT

The present disclosure is directed polymer-free, non-composite densified carbon nanotube (DCN) structures from thin carbon nanotube (CNT) films and methods of making the same. CNT thin films can be cut, folded, stacked and pre-arranged in the form of cylinders, discs, domes, frames, gaskets, jars, rings, sacks, seals and sheets on a smooth reaction vessel surface and subsequently densified with the use of chlorosulfonic acid (HClSO₃) at elevated temperatures. The disclosed DCN structures can be used as EMI shielding, lightweight structural and functional components in extreme conditions commonly encountered in space exploration, polar expeditions and military operations, and also as hydrophilic filtration media that resist surface fouling and provide high flux.

### TECHNICAL FIELD

The present disclosure generally relates to the methods of preparing additive-free, non-composite densified carbon nanotube (DCN) structures of various dimensions, specifications, thicknesses such as plates, cylinders, discs, domes, frames, gaskets, jars, rings, sacks, seals, sheets and tubes from carbon nanotube (CNT) films without the need for any polymer glue, binder, or adhesive. DCN structures are extremely lightweight with density of ˜1.3 g/cm³, durable, strong and pliable, and highly conductive. They have superior mechanical properties and withstand extreme temperatures and harsh chemicals. Due to these unique properties, DCN structures are especially effective in space exploration, polar expeditions and defense applications.

### BACKGROUND

Plastic materials (polymers) have been widely used due to the ease of processability and relative low cost to make different structures such as plates, blocks, cylinders, discs, gaskets, jars, sacks, seals, tubes and large sheets. They have some apparent drawbacks and limitations, however, such as low chemical/solvent stability and narrow operating temperature range. Their applications are especially limited in extreme environments.

For instance, in extreme cold weather (e.g., −50° C. in the polar regions and outer space), plastic materials tend to become harder, stiffer and more brittle. At elevated temperatures (e.g., 76° C.), plastics tend to become softer and more ductile. The drastic changes in plastic material's mechanical properties compromise their mechanical performance and wear resistance. In addition, many functional polymers such as neoprene, polytetrafluoroethylene (PTFE) derivatives, and polyurethane elastomers swell and/or degrade in the presence of chemicals and solvents, making them unsuitable for applications in harsh environments where sustained heavy loads and dynamic forces associated with motion are present, combined with extreme temperatures, aggressive chemicals such as sulfuric acid, hydrogen peroxide and solvents.

With constant exposure to extreme heat and cold cycling, ultrahigh vacuum, atomic oxygen, high-energy radiation (e.g., ultraviolet) and debris impact, the space environment is also extremely harsh for plastic materials. Yet materials used in space must perform as expected to ensure space mission success.

There is, therefore, a need for new materials that have much wider operating temperature range in order to overcome the constraints and limitations of polymers for applications in extreme environments. The new materials must have excellent mechanical performance to withstand sustained heavy loads and other dynamic forces associated with motion, maintain the mechanical properties (e.g., elasticity) at extreme temperatures as low as minus 200° C. and as high as 350° C. to prevent premature functional failure, and resist corrosion and degradation from long-term exposure to harsh environments and industrial chemicals and solvents.

Indeed, these requirements are extremely difficult to meet. As one of the most well-known and widely used polymer materials, PTFE is the most chemically resistant plastic available, and its integrity is maintained over a wide temperature range, from −400° F. to 500° F. (−240 to 260° C.). PTFE mechanical properties, however, are low compared to other engineering plastics. In order to improve the mechanical properties of PTFE, additives including polyfluoroalkyl substances (PFAS) are required. PFAS are “forever chemicals,” and many of them have been shown as long-term environmental and health hazards. In February 2024, EPA released two proposed regulations under the Resource Conservation and Recovery Act (RCRA) to protect communities from PFAS and other emerging chemicals of concern. As a result, new materials that can overcome the challenges associated with polymer materials are urgently needed for challenging applications.

Carbon nanotubes (CNTs) have unique properties including mechanical strength, chemical stability, and resistance to extreme temperatures to meet these challenging requirements. For instance, Miralon® sheet—a carbon nanotube (CNT) sheet from Nanocomp Technologies—has an operating temperature range from minus 200° C. to positive 200° C.

There are three main methods of CNTs synthesis, namely electric arc discharge, laser ablation and chemical vapor deposition (CVD). Depending on the reaction conditions, CNTs synthesized from these methods can be single-walled, double-walled or multi-walled. Different processes also produce CNTs with different tube lengths, different tube diameters, different tube crystallinity and so forth.

Tremendous work has been done with CNT powders to make CNT dispersions and CNT/polymer composites. Although CNT/polymer composites have improved properties compared to polymer materials, the inherent limitations of polymers are still present. Thus, CNT/polymer composites do not meet the challenges associated with extreme environments. Structures completely made of CNTs could overcome the drawbacks associated with plastic structures and CNT/polymer composite structures.

Most CNTs available in the market today are in the powder form with typical tube lengths of a few micrometers or less. It is impractical to make strong and durable structures with CNT powders without the use of polymer binders. For instance, CNT powders can be dispersed in a solvent, then deposited on a substrate to yield a CNT film upon the removal of solvent. CNT powder dispersion can also be filtered on a filter membrane to produce a CNT film called bucky paper. Bucky paper and similar CNT films, however, are particularly fragile and prone to fracture and CNT loss.

The CVD process has made it possible to make polymer-free CNT films of reasonable strength. One CVD process involves three stages: 1) depositing metal catalyst particles on a substrate, 2) growing vertically aligned CNT forest on such a substrate and 3) drawing the CNTs from the CNT forest onto a different substrate to produce a CNT film. CNTs from this CVD process are highly aligned in the CNT film.

Another CVD process is floating catalyst chemical vapor deposition (FCCVD), developed by Nanocomp Technologies, Inc. Compared to other CNT synthesis processes, FCCVD direct deposition of as-grown raw ONT films is more feasible for scale-up production and thus more cost-efficient. Depending on how CNTs are deposited on a substrate, CNTs in FCCVD CNT films can be aligned, partially aligned, minimally aligned or non-aligned.

FCCVD has changed how we view CNTs by making very long individual CNTs (much longer than tens of micrometers) to produce binder-free, stand-alone CNT films. As-grown raw CNT films from FCCVD process are considerably more durable than bucky paper or other CNT films from CNT dispersion deposited or filtered onto a substrate. In order to further improve the CNT film strength, raw CNT films can be further mechanically compressed, calendered, stretched, and/or treated with solvents. After these processes, raw CNT films from FCCVD process can have the film tensile strength of between 20 MPa and 200 MPa.

For many practical applications, especially those in extreme environments, CNT films from CVD or FCCVD process are, however, still not durable enough due to CNT loss on contact and relatively low tensile strength. Physical means such as mechanical compression, calendering, stretching and solvent treatment are not sufficient in achieving the CNT film strength required in extreme environments.

The challenge of low tensile strength is addressed with a chemical densification process at the molecular level. Unlike mechanical compression, calendering, stretching and solvent treatment, the chemical densification process brings CNTs much closer to each other to form CNT bundles. As a result, densified carbon nanotube (DCN) films become much stronger than typical CNT films.

DCN films withstand extreme temperatures and are resistant to surface fouling, corrosion, degradation and organic solvents. DCN films also have superior mechanical properties such as high tensile strength comparable with that of steel (up to 800 MPa). They are highly conductive with electric conductivity reaching that of mercury (1×10⁶ S/m). Yet DCN films are extremely lightweight with density of ˜1.3 g/cm³, significantly lighter than aluminum (2.7 g/cm³), beryllium (1.85 g/cm³) and steel (7.85 g/cm³). DCN films have been demonstrated to be superior filtration membranes and electromagnetic interference (EMI) shielding.

FCCVD process typically produces raw CNT films with areal density of ˜0.5 g/m², ˜1 g/m², ˜3 g/m², ˜6 g/m², ˜10 g/m² to ˜40 g/m². Standard offering of raw CNT films (Miralon® sheets from Nanocomp Technologies) has an areal density of ˜10-16 g/m² in the size of 1 m×2 m. DCN film thickness from a single layer of these raw CNT films ranges from <1 μm to a few μm to ˜40 μm.

Although DCN films from a single layer of CNT film have high tensile strength, very thin single-layer DCN films are still prone to fracture and cannot sustain heavy loads. The dimensions of available CNT films can also be limited. To fully utilize the superior properties of DCN films, it is necessary to control the film thickness, shapes and dimensions to make DCN structures for a variety of applications.

For example, in order to use DCN films as strong structural components and as ballistic resistance material, methods to prepare DCN plates or blocks substantially thicker than 20 μm are needed. This would require multiple layers of CNT films to be stacked on top of each other and then densified to become one thick solid plate. For electromagnetic interference (EMI) shielding applications, multiple CNT films might need to be joined together along the film edges and densified to become one larger DCN sheet to meet the dimensional requirements. As superior EMI shielding material, DCN sheets can be made into EMI shielding tapes. Large DCN sheets can be used as reflective surfaces or panels for thermal management and as conductive surfaces for use in extreme environments. Large DCN sheets can be further integrated into panel structures for satellite systems and solar sails. To prevent lightning strikes, DCN sheets can be used as fuselage layers and Faraday cages. In other applications, cylinders, domes, seals, gaskets, jars, sacks and tubes made of DCN films could be highly desirable to withstand extreme temperatures and thermal cycles, to withstand harsh corrosive environments and chemicals. For instance, DCN jars and sacks can be ideal chemical and biological liners and containers. Many other structures and applications based on DCN sheets are also conceivable for people skilled in the art.

Conventional approaches would include the use of mechanical compression, calendering, heat and polymer glue, binders or adhesives to bring individual CNT films together. Mechanical compression, however, has limited impact at the nanometer scale and is not flexible with structures of unique dimensions. Polymer binders or adhesives have their inherent constraints and limitations. The use of polymer binders or adhesives in most instances actually compromises the electrical conductivity of CNT films. These considerations form the basis of this disclosure.

### SUMMARY

In one aspect, a process for creating a polymer-free, adhesive-free, densified carbon nanotube structure is disclosed. The process steps include contacting a plurality of layers of carbon nanotube film with an acid; heating the plurality of layers of carbon nanotube for a time resulting in a densified carbon nanotube structure, wherein the densified carbon nanotube structure has a tensile strength greater than 100 MPa and electrical conductivity greater than 1×10⁵ S/m.

In some embodiments, the process also includes placing the plurality of layers of carbon nanotube film onto a shape-imparting substrate; and removing the densified carbon nanotube structure from the shape-imparting substrate. In some embodiments, the shape-imparting substrate comprises a material that resists both acid and heat exposure. In some embodiments, the acid is chlorosulfonic acid. In some embodiments, the heating step is between 50 and 300 degrees Celsius. In some embodiments, the period of time is from thirty minutes to seventy-two hours.

In another aspect, a densified carbon nanotube structure is disclosed. The densified nanotube structure includes multiple layers of carbon nanotube films.

In some embodiments, the densified carbon nanotube structure is made up of carbon nanotube films which are prepared from synthetic methods selected from electric arc discharge, laser ablation, chemical vapor deposition, floating catalyst chemical vapor deposition, or any combination of processes thereof. In some embodiments, the carbon nanotube films are prepared from a floating catalyst chemical vapor deposition process. In some embodiments, the carbon nanotube films are prepared from a carbon nanotube dispersion filtered or deposited onto a shape-imparting substrate. In some embodiments, the carbon nanotube films are as-grown, pristine or raw, annealed, purified, partially purified, mechanically compressed, calendered, stretched, treated with solvents, or any combination thereof. In some embodiments, the carbon nanotubes films are selected from: single walled, double walled, multiwalled, or any combination thereof. In some embodiments, the carbon nanotube films are selected from aligned, partially aligned, not aligned, or any combination thereof. In some embodiments, the densified carbon nanotube structure has an areal density ranging from 0.1-40 grams per meter squared.

In some embodiments, the densified carbon nanotube structure is in a form of a cylinder, disc, dome, film, frame, gasket, jar and sheet, or any combination thereof. In some embodiments, the densified carbon nanotube structure is in a form of a conductive surface or a conductive layer. In some embodiments, the densified carbon nanotube structure is in a form of an EMI shielding material, an EMI shielding tape, a fuselage layer, or a faraday cage. In some embodiments, the densified carbon nanotube structure is in a form of a ballistic resistance material, a satellite panel, an overwrapping for pressured vessel, a reflective surface, or a reflective panel. In some embodiments, the densified carbon nanotube structure is in a form of a container or a sack further included in a chemical or biological liner. In some embodiments, the densified carbon nanotube structure is in a form of a filtration media, where the filtration media is further characterized as a bioprocessing, a semiconductor processing, a chemical processing, an industrial water processing, a food processing, a wastewater management, a hydrogen production, an electrolysis, or a battery production implement.

One embodiment of the subject matter provides a method to densify multiple layers of raw CNT films to make a thick DCN sheet [FIG. 1 (A)]. Raw CNT films of the specified sizes are stacked up and placed on the smooth surface in a reaction vessel that is composed of glass, ceramic or other acid and heat resistant material, wet with water, compressed gently so all CNT films adhere together. Upon drying in air to remove water, chlorosulfonic acid (HClSO₃) is sprayed or deposited evenly on the stack of raw CNT films. Upon heating, raw CNT films densify to form an integral DCN sheet.

In a further embodiment, raw CNT films of specific sizes are annealed under inert atmosphere to remove amorphous carbon, then stacked up and placed on the smooth surface in a reaction vessel that is composed of glass, ceramic or other acid and heat resistant material, wet with water, compressed gently so all annealed CNT films adhere together. Upon drying in air to remove water, HClSO₃ is sprayed or deposited evenly on the stack of annealed CNT films. Upon heating, annealed CNT films densify to form an integral DCN sheet [FIG. 1 (B)].

In another embodiment, raw CNT films of the specific sizes are annealed under inert atmosphere to remove amorphous carbon, then soaked in aqueous acid solution, rinsed with water, stacked up and placed on the smooth surface in a reaction vessel that is composed of glass, ceramic or other acid and heat resistant material, compressed gently so all purified CNT films adhere together. Upon drying in air to remove water, HClSO₃ is sprayed or deposited evenly on the stack of purified CNT films. Upon heating, the purified CNT films densify to form an integral DCN sheet [FIG. 1 (C)].

In yet a further embodiment, raw CNT films of the specific sizes are annealed under inert atmosphere to remove amorphous carbon, soaked in aqueous acid solution, rinsed with water and then dried in air to yield purified CNT films. Purified CNT films are then stacked up and placed on the smooth surface in a reaction vessel that is composed of glass, ceramic or other acid and heat resistant material, compressed gently so all purified CNT films adhere together. Upon drying in air to remove water, HClSO₃ is deposited evenly on the stack of purified CNT films. Upon heating, purified CNT films densify to form an integral DCN sheet [FIG. 1 (D)].

Without deviating from the above embodiments, different DCN structures such as cylinders, discs, domes, frames, gaskets, jars, plates, rings, sacks, seals, tubes and large sheets can be made with raw, annealed, purified or partially purified CNT films of same or different areal densities, or any combination thereof, as long as the reaction vessel can accommodate such structural designs and dimensions. These structures significantly broaden the applications of DCN materials beyond films.

### BRIEF DESCRIPTION OF THE DRAWINGS

FIG. 1. Processes of annealing (heat, inert atmosphere), purification (aqueous acid solution) and densification (A, B, C or D) of CNT films. Raw CNT films, annealed CNT films and purified CNT films can be densified to produce DCN sheets.

FIG. 2. Individual carbon nanotube 1 is a gigantic molecule composed of carbon atoms 2 with charge separation 3 along the carbon nanotube surface. The gigantic molecule as a whole is charge neutral but neighboring carbon atoms have opposite partial charges. (A) cross-sectional view; (B) longitudinal view; (C) charge separation leads to the formation of an orderly water layer 5 around individual carbon nanotube 1 and the presence of a dense gas layer 4 between the carbon nanotube surface and the water layer 5.

FIG. 3. (A) Intermolecular Electrostatic Attraction 6 between two neighboring carbon nanotubes brings carbon nanotubes close to each other; (B) Intermolecular Pi-Pi Stacking 7 extends the Pi bond conjugation to further stabilize charge separation approaching a formal charge of plus one and minus one among carbon atoms in a DCN film.

FIG. 4. (A) SEM image of DCN film surface shows an Individual CNT Bundle 8 and the presence of Nanometer Pores 9. DCN film has a Reflective Surface 10 with a smooth and shiny metallic luster, likely due to electrostatic attraction, extensive mr bond conjugation and IT stacking.

FIG. 5. (A) Disorderly Entanglement of Polymeric Chains 11 in a polymer matrix. (B) SEM image of Chemically Densified Carbon Nanotube Bundles 12 in a DCN film showing little or no entanglement.

FIG. 6. Without the use of glue or adhesives, two CNT films 13 with a Film Edge overlapping are joined together after the densification process. This forms a larger DCN film 14 with a Chemically Densified Seam.

FIG. 7. Multiple layers of CNT Film 13 are stacked up, gently pressed and treated with HClSO₃ for densification to yield a thick Densified Carbon Nanotube Sheet 15.

FIG. 8. A Densified Carbon Nanotube Sheet 15 can be bent (A), twisted (B) and returned to its original state (C) and remain undamaged.

FIG. 9. CNT films of different areal densities and pattern designs are stacked up, gently pressed and treated with HClSO₃ for densification to yield a DCN Sheet 16 with a Differential Areal Density.

FIG. 10. Multiple layers of CNT film discs are stacked up, gently pressed and treated with HClSO₃ for densification to yield a thick Densified Carbon Nanotube Disc Shaped Sheet 17.

FIG. 11. Multiple layers of CNT films with gasket design are stacked up, gently pressed and treated with HClSO₃ for densification to yield a thick Densified Carbon Nanotube Gasket 18.

FIG. 12. A CNT film is placed on the smooth surface of a reaction vessel, rolled up to form a cylindrical shape with both ends overlapping, and further densified to yield a Densified Carbon Nanotube Cylindrical Shape 19.

FIG. 13. CNT films can be placed on the smooth surface of a reaction vessel with edges overlapping and densified to form objects such as DCN frame 20, DCN ring 21, DCN dome 22 and DCN jar (sack) 23.

### DETAILED DESCRIPTION

Without wishing to be bound to any particular theory, the following description identifies various facets of the invention and its uses.

Referring to FIG. 1, CNTs are composed of extended aromatic structures and each Individual CNT 1 can be viewed as a gigantic molecule. Individual CNTs are exceptionally strong due to the strong carbon-carbon bonds in the individual CNT molecule. Raw, thin CNT films typically are, however, quite delicate and prone to fracture. Without polymer binders, CNT films also suffer from CNT loss. The poor mechanical strength of CNT films is due to a dense gas layer 4 and the orderly water layer 5 encapsulating individual CNTs that weakens an intermolecular electrostatic attraction 6 and the intermolecular pi-pi stacking 7.

Bringing individual CNTs 1 closer to one another can increase the force of intermolecular electrostatic attraction 6 and, therefore, lead to stronger CNT films. Physical means such as mechanical compression to densify CNT films are not effective when CNT films are thinner than 50 μm. A chemical approach is required to prepare CNT films that are physically more robust and durable.

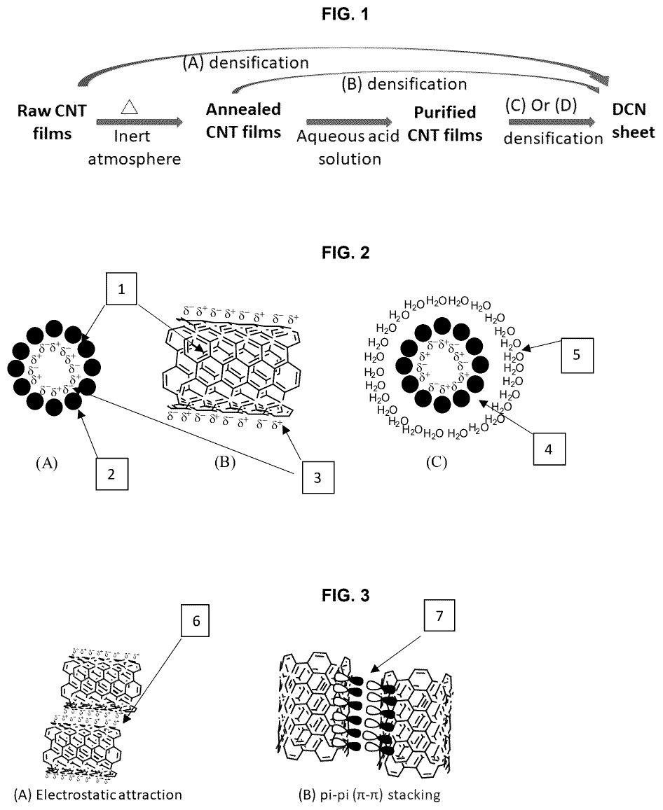

A few forces are at play at a CNT surface. According to molecular orbital theory, in each individual CNT molecule, there are molecular π (pi) orbitals formed by the conjugation of 2p orbitals from each carbon atom 2. Extended conjugation lowers the energy level of the π orbitals and stabilizes the gigantic CNT molecule. Extended conjugation of 2p orbitals also stabilizes the non-uniform electron density distribution across CNT surface. Non-uniform electron density distribution across CNT surface can be interpreted as having strong dipoles or alternating positive and negative charges (or partial charges) (see FIGS. 2A and 2B). Charge separation across CNT surface would dramatically increase the intermolecular electrostatic attraction among individual CNTs.

The CNT-air interface, however, plays a significant role in keeping individual CNTs away from each other. When an individual CNT gigantic molecule comes in contact with air, it will invariably interact with air and water molecules in air. Recent molecular simulation work shows that a dense gas layer 4 resides between CNT surface and the orderly water layer 5 when equilibrated with a normal pressure of 1 atmosphere and temperature of 300 K. Experimental evidence also suggests that an adsorption layer of water forms around individual CNTs, establishing a nanometer gap between CNT surfaces and the water layer 5 (FIG. 2C). Dense gas could exist in this nanometer gap space. The presence of the dense gas layer 4 and orderly water layer 5 near individual CNT surface effectively counterbalances the intermolecular attraction force among individual CNT molecules. As a result, CNT films can only reach limited tensile strength after mechanical processes including compression, calendering, stretching and solvent treatment.

The chemical approach to densify CNT films needs to eliminate the orderly water layer 5 and the dense gas layer 4 at individual CNT surface. HClSO₃ is highly hygroscopic. Upon heating, the orderly water layer 5 is completely removed. As CNTs slowly come closer to each other, dense gas layer 4 is also squeezed out. The sheer attraction force among CNTs is then fully manifested to result in much more durable and robust densified carbon nanotube (DCN) films.

The mechanical properties of DCN films are largely determined by two major attractive forces between carbon nanotube molecules: electrostatic interaction 6 and pi (π) stacking (also called π-π stacking 7). Based on molecular orbital theory, extensive π bond conjugation stabilizes charge separation along individual carbon nanotubes (FIGS. 2A and 2B), leading to increased electrostatic interactions between carbon nanotube molecules. Chemical densification brings carbon nanotubes much closer to each other to align and bundle, further enhancing electrostatic attraction (FIG. 3A). The close proximity of individual carbon nanotubes in DON film also leads to the extensive, noncovalent IT orbital interactions (orbital overlap) in neighboring carbon nanotubes (FIG. 3B), further strengthening the attraction force between carbon nanotubes. As a result, the attraction force between neighboring carbon nanotubes in a DON film is much stronger than the typical intermolecular attraction force among polymer chains, rendering DCN films much stronger than typical polymer materials.

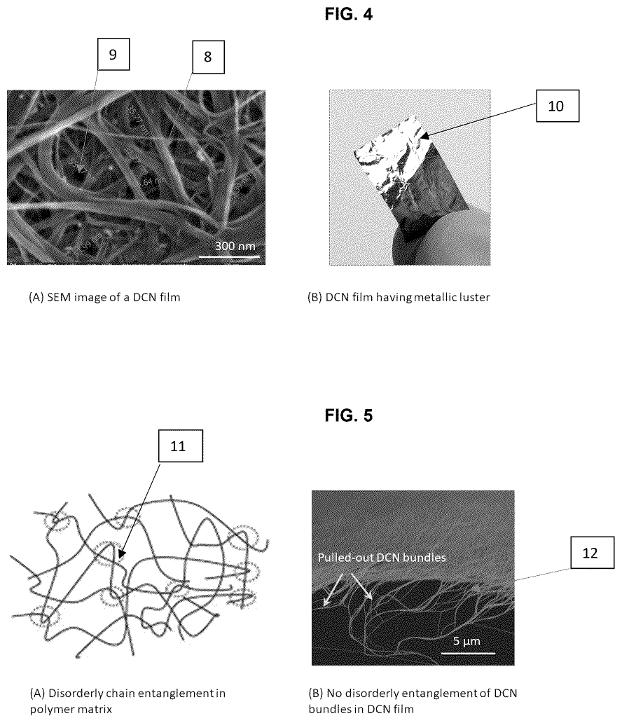

DCN films appear silvery, unlike dull black pristine CNT sheets. SEM images indicate that the pore sizes in DCN films are small in the nanometer range, with uniform CNT bundling (see FIG. 4A). Extensive conjugation between bundled DCN results in further stabilization of charge separation across the DCN films. Extensive charge separation could be responsible for the metallic luster of DCN films (FIG. 4B).

DCN films have improved tensile strength of up to 800 MPa (vs. 20˜200 MPa for raw CNT films, and <50 MPa for polymers). DCN films are also much thinner and more electrically conductive with conductivity reaching 1×10⁶ S/m (from ca. 5×10⁴ S/m in raw CNT films) and electrical resistivity of less than 0.5 Ω/square, making them ideal conductive surfaces. DCN films also demonstrate exceptional chemical and physical stability in extreme environments including extremely low temp (−50° C. and below) and high temperatures (100° C. and above), high humidity and acid/alkali conditions and aggressive solvents. The combination of these properties significantly overcomes the limitations of polymer materials including PTFE-based materials

The root cause for polymer material failure under extreme cold temperatures is the entanglement of polymer chains in a disorderly matrix (FIG. 5A). Polymer chain entanglement 11 limits the movement of polymer chains. Most polymers have poor thermal conductivity. When the external temperature drops, a temperature gradient forms in the polymer structure, and the polymer structure begins to stiffen up and go through the ‘glass transition’ becoming very hard and brittle. Because polymer chains cannot slide in the glassy state, entangled polymer chains break or fracture under pressure or stress, leading to the deterioration of the mechanical and chemical resistance properties and consequently performance failures in polymer material. The entanglement of polymer chains also allows empty space in the disorderly matrix. As a result, chemicals and solvents can creep into the empty space between the polymer chains causing swelling and changes to the mechanical properties and over time, degradation of polymer material.

DCN technology eliminates the above challenges in three significant ways: 1) carbon nanotubes are chemically stable and resist corrosion even in the harshest environments; 2) densification of carbon nanotubes facilitates orderly bundling and are ideally suited for cold temperatures as low as −200° C. in dynamic environments. As shown in FIG. 5B, carbon nanotubes are bundled and aligned in DCN film. Aligned individual carbon nanotubes in bundles can slide along the bundle direction, and there will be no carbon nanotube breakage under stress or at extremely low temperatures, maintaining the ductility of a DCN film across a wide operating temperature range. In addition, carbon nanotubes are excellent thermal conductors along the axial direction. Aligned carbon nanotube bundles ensure there is no temperature gradient in a DON structure, eliminating stress on the DCN structure as temperature drops to extreme cold. Furthermore, DCN structures withstand extremely high temperature (above 1000° C. in inert atmosphere and at least 350° C. in air); 3) densifying commercially available FCCVD CNT sheets (e.g., Miralon® sheets) also eliminates the empty space in the matrix and prevents small molecules such as chemicals and solvents from creeping into a DON film matrix. Hence, no swelling occurs in DON film when exposed to harsh chemicals and solvents.

Because of the combined superior physical and chemical properties, DCN films have many potential applications in military operations, space explorations, and polar expeditions where extreme environments are the norm. In applications where large DCN films are required, it is necessary to join multiple CNT films to form a considerably larger DCN film without the use of glue or adhesives. In applications with heavy loads, it is necessary to make CNT films of 10-20 μm thickness into DCN structures of hundreds of μm to even mm in thickness. In other applications, it is necessary to make DCN containers such as cylinders, tubes, jars, sacks and liners from CNT films.

Commercial raw CNT films are limited in dimension and thickness. For example, Miralon® sheets from Nanocomp Technologies are only available in 1 m×2 m size with areal densities of 10-12 g/m² and 25-30 g/m². To meet the application requirements in extreme environments, it is critical to develop methods of making DCN structures using the available CNT films.

Commercial CNT films also contain various amount of amorphous carbon and catalyst particles depending on the CNT production conditions. The amount of amorphous carbon and catalyst particles can have an impact on the chemical densification process. In some instances, raw CNT films can be used directly for densification to yield DCN structures. In other instances, raw CNT films need to be annealed before densification to yield DCN structures. In some additional instances, raw CNT films need to be purified further by annealing and subsequent acid soak to remove amorphous carbon and catalyst particles. The purified CNT films can subsequently be used for densification to yield DCN structures.

Densification of raw CNT films, annealed CNT films, and purified CNT films provides an effective way to manufacture DCN structures of various dimensions and shapes without the need for any polymeric glue, binder, or adhesive. A large variety of available DCN structures will replace their polymer counterparts to enable critical applications and processes in extreme environments.

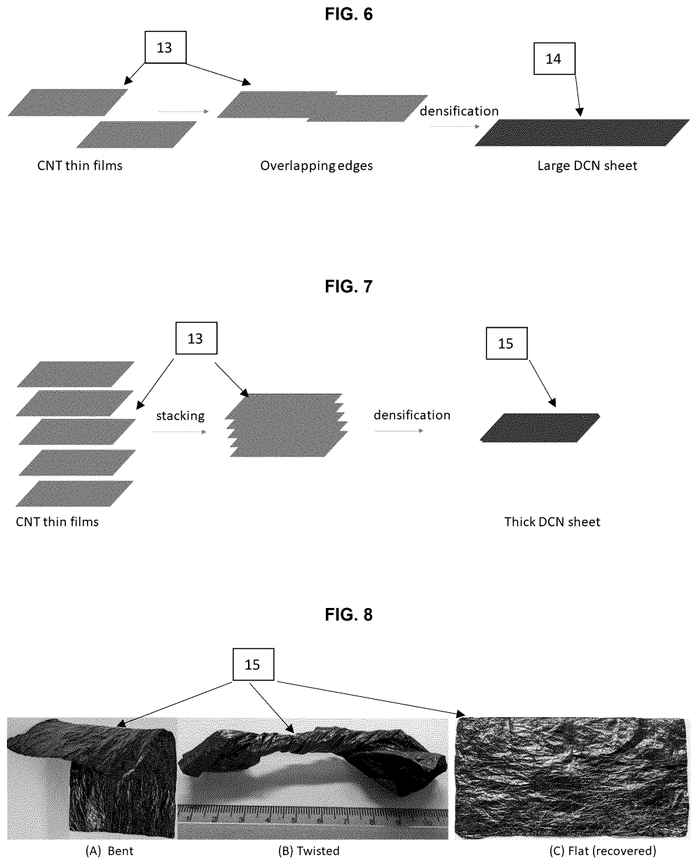

To illustrate the densification process, two smaller CNT films 13 are placed side by side with some overlap on a smooth wet glass surface inside a glass vessel (FIG. 6). Upon drying, chlorosulfonic acid (HClSO₃) is sprayed or deposited evenly onto the CNT films and the glass vessel is closed to minimize moisture exposure. Once all CNT film area appears wet by HClSO₃, the glass vessel is heated at elevated temperatures from about 50° C. to about 200° C., preferably from about 70° C. to about 175° C. for an extended period of time from a few hours to over 100 hours, most preferably 12 hours to 24 hours to 72 hours. As HClSO₃ slowly evaporates, CNTs densify to form a mirror-like smooth, shiny film on the glass surface. Upon rinsing with water, the shiny film comes off from the glass surface in one integral piece. Two individual smaller CNT films 13 are thus joined together during the densification process without the need for any polymer glue, binder or adhesive to yield a larger DCN sheet 14. A large DCN sheet can be effective as a conductive surface or as an EMI shielding material.

In some embodiments, the chlorosulfonic acid may be substituted with any strong, hygroscopic, inorganic acids. Examples of such acids include fluorosulfonic acid, fuming sulfuric acid or oleum, sulfuric acid and fuming nitric acid.

In a similar fashion, a DON sheet of desired thickness can be prepared by stacking multiple polymer-free Miralon® sheets of ca. 10-12 g/m² areal density on top of each other, and subsequently densifying the stack in the presence of HClSO₃. Multiple CNT films 13 are slightly wet and stacked up on a smooth wet glass surface inside a glass vessel (FIG. 7). Upon drying, HClSO₃ is sprayed or deposited evenly onto the CNT film stack and the glass vessel is closed to minimize moisture exposure. Once all CNT films are wet by HClSO₃, the glass vessel is heated at elevated temperatures from about 50° C. to about 200° C., preferably from about 70° C. to about 175° C. for an extended period of time from a few hours to over 100 hours, most preferably 12 hours to 24 hours to 72 hours. As HClSO₃ slowly evaporates, CNTs densify to form a silvery stack on the glass surface. Upon rinsing with water, the silvery stack comes off from the glass surface in one integral piece. Multiple CNT films are joined together during the densification process without the need for any polymer glue, binder or adhesive to yield a thick DCN sheet 15.

Thick DCN sheet 15 can be bent, twisted, kneaded, flattened and returned to its original state and remain undamaged (FIG. 8). Unlike carbon fiber or CNT composite material, the recovered DON sheet does not show any tearing or creasing.

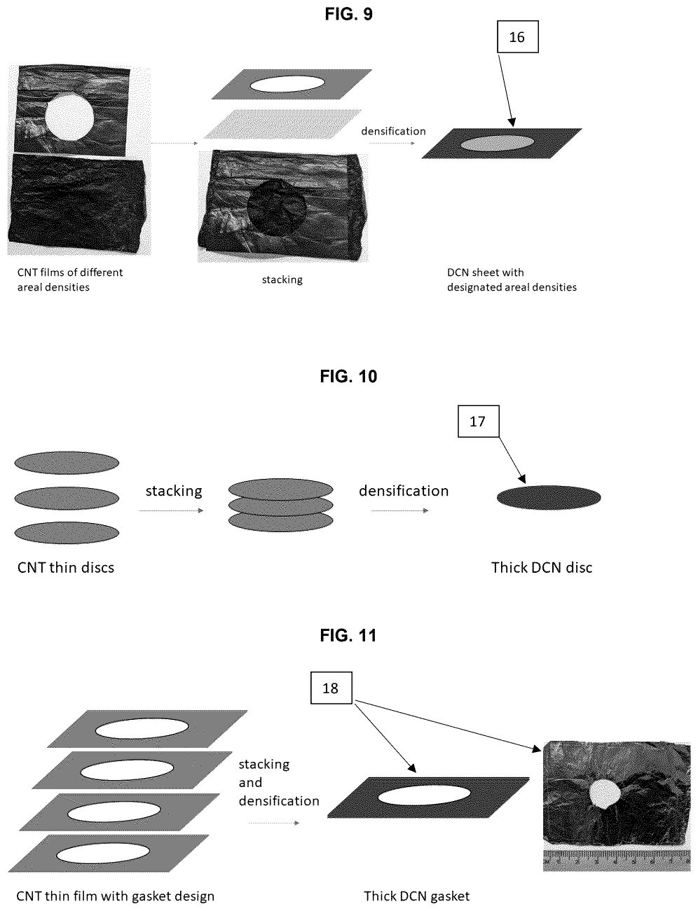

CNT films of multiple different areal densities can be densified together to make DON sheets. For example, a CNT film of ca. 10-12 g/m² areal density with a circular opening can be stacked on top of a raw CNT sheet of ˜0.5 g/m² areal density (FIG. 9). Upon densification, a DCN sheet 16 having designated areas with specific areal densities can be made. DCN sheets with different areal densities have different properties. For instance, DCN sheets of ˜0.5 g/m² areal density are semi-transparent and have large flux when used for liquid filtration. On the other hand, DCN sheets of ˜10-12 g/m² areal density have much lower flux and are considerably more durable to handle. As a result, DCN sheets 16 with multiple areal densities can be advantageously constructed to perform multiple functions. For example, due to the unique chemical stability, DCN sheets 16 with multiple areal densities are unique filtration media for bioprocessing, semiconductor manufacturing, chemical processing, industrial and water filtration, food processing, wastewater management. DCN sheets 16 with multiple areal densities can also find applications in hydrogen production, electrolysis, and battery production.

Raw CNT films with patterns can be densified to make DCN structures with patterns. For instance, CNT film discs can be stacked up on a smooth wet glass surface inside a glass vessel (FIG. 10) and then densified to form a silvery sheet on the glass surface. Upon rinsing with water, the silvery sheet comes off from the glass surface in one integral piece. Multiple CNT film discs are joined together during the densification process without the need for any polymer glue, binder or adhesive to yield a thick DCN disc 17.

In some embodiments, the smooth wet glass surface can be substituted with any shape-imparting substrate desired. Examples of such shape-imparting substrates include flat surfaces, curved surfaces, and the like. In some embodiments, the shape-imparting substrate is a preformed glass or ceramic shape prepared from a cast mold. In some embodiments, the shape-imparting substrate is a flask. In some embodiments, the shape-imparting substrate is a cylinder. In some embodiments, the shape-imparting substrate is a dome.

CNT films with gasket design pattern can be stacked up on a smooth wet glass surface inside a glass vessel (FIG. 11) and densified to form a silvery stack on the glass surface. Upon rinsing with water, the silvery stack comes off from the glass surface in one integral piece. Multiple CNT films with gasket pattern are joined together during the densification process without the need for any polymer glue, binder or adhesive to yield a thick DCN gasket 18.

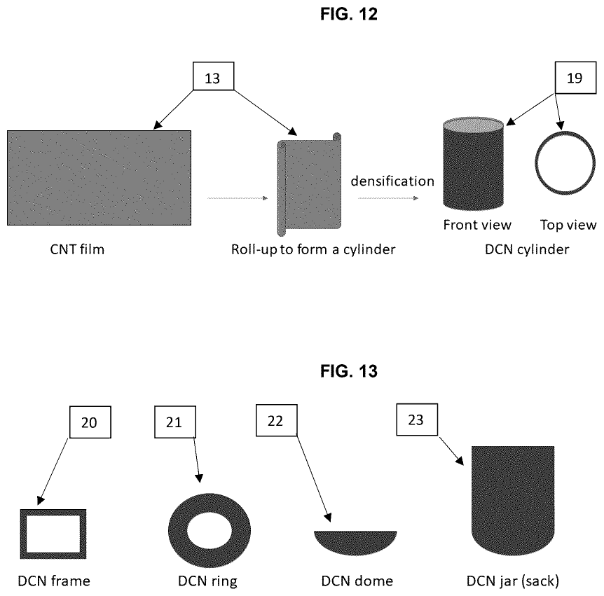

A raw CNT film that is longer than the inner periphery of the glass vessel wall can be placed on the inner wall to form a DCN cylinder 19 (FIG. 12). Alternatively, multiple CNT films can be stacked to make a considerably thicker DCN cylinder 19.

Raw CNT films can be cut and arranged to make DCN frame 20, DCN ring 21, and DCN containers such as a dome 22 and a jar 23 (FIG. 13), just to mention a few. Because DCN sheets are ductile, a DCN jar 23 can also be used as a sack, or as overwrapping material for a pressure vessel. Being ductile with superior chemical and biological resistance, a DCN jar (or sack) 23 is also ideal material as chemical and biological container liner.

DCN films provide EMI shielding across a wide frequency range. DCN films can also be used as lightweight and durable structural components such as solar sails in outer space. DCN films also have unique thermal properties—an excellent thermal conductor in the plane of the film but a poor thermal conductor perpendicular to the plane. Combined with reflectivity, being lightweight and ductile, DCN films can be especially useful in thermal management in space exploration. For instance, DCN films can be the thermal insulation layer for extravehicular activity (EVA) suits during planetary exploration (e.g. Mars) to replace aluminized Mylar® films. DCN films can also be used as boot outsoles, pads on the EVA glove and knee on the EVA suit in extreme thermal environments such as Mars or the Moon.

Depending on the film thickness and film pore sizes, DCN films can also be used as universally compatible filtration membranes to remove bacteria, viruses, microplastics and nanoplastics in liquids and gases. Because of the exceptional chemical and physical stability and controllable film pore sizes, DCN films can find applications across multiple industries including semiconductor, electronics, bioprocessing, chemical, food, and water industries.

Thick DCN sheets and structures are able to withstand heavy loads. With the combination of unique properties that include extreme temperature tolerance, chemical/solvent resistance, ductility, large tensile strength and being extremely lightweight, DCN sheets and structures such as discs, domes, gaskets, jars, rings, seals, and sacks can find multiple applications in space exploration such as the lunar Artemis mission to enable the long-term presence of humans in space and, in military operations including polar expeditions where extreme temperatures are normal. Under those extreme conditions, conventional metal and polymer structures would invariably underperform or even fail.

### EXAMPLES

Two raw CNT films (˜25 cm×13.5 cm each, 0.7291 g combined) were placed in a tube furnace and annealed under inert atmosphere at 1000° C. for 4 h. Upon cooling to ambient temperature, both films were removed from the tube furnace, weighed (0.6649 g), positioned and flattened on the bottom of a glass jar to result in the overlapping of two edges (˜1 cm) that met in the center. Upon drying in air at 50° C. for 16 h, the jar was cooled to room temperature under nitrogen and subsequently chlorosulfonic acid (5.83 g, 3.33 mL) was deposited across the CNT films. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (500 mL) was then poured into the jar immediately. After a vapor cloud (smoke-like appearance) subsided, the product was removed from the jar, rinsed with water and dried in air to yield a shiny, silvery pliable DCN sheet (0.6608 g, ˜25 cm×25 cm) that is ductile and durable.

A raw thin CNT film (0.37188 g, areal density ˜11.9 g/m², size 12.5 cm×25 cm) was cut into two 12.5 cm×12.5 cm CNT film. The smooth bottom surface of a large glass jar with a ground mouth opening was slightly wet with water. One CNT film was placed in the center of the bottom, flattened and wet slightly with water spray. The other CNT film was then stacked right on top of the first film and smoothed out to remove any visible air pockets. The jar was placed on a hot plate at 50° C. to dry the CNT films in air. After sufficient time, the jar was cooled to ambient temperature and purged with N₂. HClSO₃ (3.72 g, 2.12 mL) was deposited across the CNT films. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (500 mL) was then poured into the jar immediately. After a vapor cloud (smoke-like appearance) subsided, the product was removed from the jar, rinsed with water and dried in air to yield a shiny, silvery pliable DCN sheet (0.4124 g, 12.5 cm×12.5 cm) that is ductile and durable.

A raw thin CNT film (0.65151 g, areal density ˜11.9 g/m², size 25 cm×25 cm) was cut into four 12.5 cm×12.5 cm CNT films. A jar bottom was wet with water spray and one CNT film was placed in the center of the bottom, flattened and wet slightly with water spray. The other three CNT films were then stacked right on top of the first film and smoothed out to remove any visible air pockets. The jar was placed on a hot plate at 50° C. to dry the CNT films in air. After sufficient time, the jar was cooled to ambient temperature and purged with N₂. HClSO₃ (6.515 g, 3.72 mL) was deposited across the CNT sheets. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (500 mL) was then poured into the jar immediately. After a vapor cloud (smoke-like appearance) subsided, the product was removed from the jar, rinsed with water and dried in air to yield a shiny, silvery pliable DCN sheet (0.7136 g, 12.5 cm×12.5 cm) that is ductile and durable.

A raw thin CNT film (1.3957 g, areal density ˜11.9 g/m², size 25 cm×50 cm) was cut into eight 12.5 cm×12.5 cm CNT films. A jar bottom was wet with water spray and one CNT film was placed in the center of the bottom, flattened and wet slightly with water spray. The other seven CNT films were then stacked right on top of the first film and smoothed out to remove any visible air pockets. The jar was placed on a hot plate at 50° C. to dry the CNT films in air. After sufficient time, the jar was cooled to ambient temperature and purged with N₂. HClSO₃ (13.96 g, 7.96 mL) was deposited across the CNT films. A ground glass stopper was placed on the jar to prevent moisture exposure. After 3 h at ambient temperature, the jar was placed on a hot plate at 50° C. for 12 h and subsequently at 175° C. for 12 h. The stopper was then opened slightly before the jar was placed in a water bath. Water (500 mL) was then poured into the jar immediately. After a vapor cloud (smoke-like appearance) subsided, the product was removed from the jar, rinsed with water and dried in air to yield a shiny, silvery pliable DCN sheet (1.5360 g, 12.5 cm×12.5 cm) that is ductile and durable.

A raw thin CNT film (1.3148 g, areal density ˜11.9 g/m², size 25 cm×50 cm) was cut into sixteen 12.5 cm×6.25 cm CNT films. A jar bottom was wet with water spray and one CNT film was placed in the center of the bottom, flattened and wet slightly with water spray. The other fifteen CNT films were then stacked right on top of the first film and smoothed out to remove any visible air pockets. The jar was placed on a hot plate at 50° C. to dry the CNT films in air. After sufficient time, the jar was cooled to ambient temperature and purged with N₂. HClSO₃ (13.15 g, 7.5 mL) was deposited across the CNT films. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (500 mL) was then poured into the jar immediately. After a vapor cloud (smoke-like appearance) subsided, the product was removed from the jar, rinsed with water and dried in air to yield a shiny, silvery pliable DCN sheet (1.4359 g, 12.5 cm×6.25 cm) that is ductile and durable.

A raw thin CNT film (5.08 mg, areal density ˜0.6 g/m², size ˜7.5 cm×11 cm) was placed on a jar bottom that was wet with water spray. The CNT film was carefully flattened and centered in the jar. A second CNT film (52.22 mg, areal density ˜12 g/m², size ˜7.5 cm×10 cm) with a circle (diameter ˜4.5 cm) cut off in the center, was laid over the first thin CNT film, pressed gently to remove any visible ridges and bubbles. The jar was then heated at 50° C. to dry the CNT films in air. After sufficient time, the jar was cooled to ambient temperature and purged with N₂. HClSO₃ (1.16 g, 0.66 mL) was deposited across the CNT films. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (100 mL) was then poured into the jar immediately. After a vapor cloud (smoke-like appearance) subsided, the product was removed from the jar, rinsed with water and dried in air to yield a shiny, silvery pliable DCN sheet (63.78 mg, ˜7.5 cm×10 cm with a semi-transparent circle in the center) that is ductile and durable.

Three raw thin CNT discs of penny size (3.80 mg in total, areal density ˜12 g/m²) were placed on a wet jar bottom layer by layer. The CNT discs were carefully flattened and centered in the jar. The jar was then heated at 50° C. to dry the CNT sheets in air. After sufficient time, the jar was cooled to ambient temperature and purged with N₂. HClSO₃ (85 mg, 50 μL) was deposited across the CNT discs. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (100 mL) was then poured into the jar immediately. After a vapor cloud (smoke-like appearance) subsided, the product was removed from the jar, rinsed with water and dried in air to yield a shiny, silvery DCN disc (4.24 mg) that is ductile and durable.

Four raw CNT films with a gasket design (83.65 mg in total, areal density ˜12 g/m²) were placed on a wet jar bottom layer by layer. The CNT films were carefully flattened and centered in the jar. The jar was then heated at 50° C. to dry the CNT films in air. After sufficient time, the jar was cooled to ambient temperature and purged with N₂. HClSO₃ (0.84 g, 0.48 mL) was deposited across the CNT films. A ground glass stopper was placed on the jar to prevent moisture exposure. After 3 h at ambient temperature, the jar was placed on a hot plate at 50° C. for 12 h and subsequently at 130° C. for 12 h. The stopper was then opened slightly before the jar was placed in a water bath. Water (100 mL) was then poured into the jar immediately. After a vapor cloud (smoke-like appearance) subsided, the product was removed from the jar, rinsed with water and dried in air to yield a shiny, silvery DCN gasket (93.20 mg, ˜5 cm×8 cm) that is ductile and durable.

What is claimed is:

1. A process for creating a polymer-free, adhesive-free, densified carbon nanotube structure, comprising:
contacting a plurality of layers of carbon nanotube film with a strong, hygroscopic, inorganic acid; and
heating the plurality of layers of carbon nanotube film for a period of time resulting in a densified carbon nanotube structure;
wherein the densified carbon nanotube structure has a tensile strength greater than 100 MPa and electrical conductivity greater than 1×10⁵ S/m.

2. The process of claim 1, further comprising:
placing the plurality of layers of carbon nanotube film onto a shape-imparting substrate; and
removing the densified carbon nanotube structure from the shape-imparting substrate.

3. The process of claim 2, wherein the shape-imparting substrate comprises a material that resists both acid and heat exposure.

4. The process of claim 1, wherein the acid is chlorosulfonic acid.

5. The process of claim 1, wherein the heating step is between 50 and 300 degrees Celsius.

6. The process of claim 1, wherein the period of time is from thirty minutes to seventy-two hours.

7. A densified carbon nanotube structure comprising multiple layers of carbon nanotube films.

8. The densified carbon nanotube structure of claim 7, wherein the carbon nanotube films are prepared from synthetic methods selected from: electric arc discharge, laser ablation, chemical vapor deposition, floating catalyst chemical vapor deposition, or any combination of processes thereof.

9. The densified carbon nanotube structure of claim 7, wherein the carbon nanotube films are prepared from a floating catalyst chemical vapor deposition process.

10. The densified carbon nanotube structure of claim 7, wherein the carbon nanotube films are prepared from a carbon nanotube dispersion filtered or deposited onto a shape-imparting substrate.

11. The densified carbon nanotube structure of claim 7, wherein the carbon nanotube films are as-grown, pristine or raw, annealed, purified, partially purified, mechanically compressed, calendered, stretched, treated with solvents, or any combination thereof.

12. The densified carbon nanotube structure of claim 7, wherein the carbon nanotube films are selected from: single walled, double walled, multiwalled, or any combination thereof.

13. The densified carbon nanotube structure of claim 7, wherein the carbon nanotube films are selected from aligned, partially aligned, not aligned, or any combination thereof.

14. The densified carbon nanotube structure of claim 7, wherein the carbon nanotube structure has an areal density ranging from 0.1-40 grams per meter squared.

15. The densified carbon nanotube structure of claim 7 in a form of a cylinder, disc, dome, film, frame, gasket, jar and sheet, or any combination thereof.

16. The densified carbon nanotube structure of claim 7 in a form of a conductive surface or a conductive layer.

17. The densified carbon nanotube structure of claim 7 in a form of an EMI shielding material, an EMI shielding tape, a fuselage layer, or a faraday cage.

18. The densified carbon nanotube structure of claim 7 in a form of a ballistic resistance material, a satellite panel, an overwrapping for pressured vessel, a reflective surface, or a reflective panel.

19. The densified carbon nanotube structure of claim 7 in a form of a container or a sack further included in a chemical or biological liner.

20. The densified carbon nanotube structure of claim 7 in a form of a filtration media, wherein the filtration media is further characterized as a bioprocessing, a semiconductor processing, a chemical processing, an industrial water processing, a food processing, a wastewater management, a hydrogen production, an electrolysis, or a battery production implement.
